(19) United States
(12) Patent Application Publication
(10) Pub. No.: US 2005/0160759 A1
(43) Pub. Date: Jul. 28, 2005

(54) Chiller reservoir with internal baffles

(75) Inventors: David B. Chaney, Westerville, OH (US); John E. Deeds, Sugar Grove, OH (US)

Correspondence Address: KELLY LOWRY & KELLEY, LLP, 6320 CANOGA AVENUE, SUITE 1650, WOODLAND HILLS, CA, 91367, US

(73) Assignee: Oasis Corporation

(21) Appl. No.: 11/042,650

(22) Filed: Jan. 24, 2005

Related U.S. Application Data
(60) Provisional application No. 60/539,458, filed on Jan. 26, 2004.

(51) Int. Cl. F25B 21/02; B67D 5/62; F25D 11/00

(52) U.S. Cl. 62/389; 62/430

(57) ABSTRACT

A chiller reservoir is provided for use in a water cooler or the like for chilling a supply of water, and defines a substantially enclosed volume having a refrigerated outer wall carrying a chiller coil or the like for chilling water contained within the reservoir. An inlet port at a reservoir first end admits water to a central inlet tube for discharge into the reservoir near a reservoir second end. A plurality of spaced-apart baffle plates are mounted within the reservoir and have apertures formed therein to cause the water to flow from the reservoir second end along a direction-changing path back toward an outlet port at the reservoir first end. This direction-changing path directs or guides the water to flow toward and/or against the refrigerated outer wall, or against an ice bank formed thereon, for improved and relatively rapid chilling.

This application claims the benefit of U.S. Provisional Application 60/539,458, filed Jan. 26, 2004.

### BACKGROUND OF THE INVENTION

This invention relates generally to improvements in refrigerated water coolers of the type having a water reservoir for receiving and storing a supply of water, and for selectively dispensing water from the reservoir. More particularly, this invention relates to an improved chiller reservoir incorporating at least one and preferably a plurality of internal baffles having flow apertures formed therein for circulating water within the reservoir in a manner to achieve improved and relatively rapid chilling of the water.

Water coolers in general are well known in the art for containing a supply of water in a convenient manner and location ready for substantially immediate dispensing and use. Such water coolers commonly include a reservoir mounted within a cooler housing or cabinet and adapted to receive an inflow of water from a suitable water supply or source, such as from an inverted water bottle of typically three to five gallon capacity, or an alternate source such as a tap water supply or the like which may be filtered or otherwise treated (e.g., by means of a reverse osmosis purification system or the like) to remove undesired levels of contaminants. The water within the reservoir is adapted for selective dispensing through one or more faucet valves located at an accessible position, such as on the front of the cooler housing, or alternately on a countertop or other convenient location.

In many water coolers, refrigeration means are provided for reducing the temperature of the water contained within the reservoir to a chilled, refreshing temperature. A typical refrigeration system includes an evaporator cooling or chiller coil or the like wrapped about or otherwise incorporated into an outer wall of the reservoir, in relatively close heat transfer relation with water contained within the reservoir. Such chiller coil comprises a portion of a conventional mechanical refrigeration system for circulating a low temperature refrigerant through the chiller coil. The refrigeration system is commonly cycled on and off in a manner producing an ice bank or ring lining the peripheral interior of the reservoir outer wall, for direct contact with and direct chilling of the water contained within the reservoir.

The presence of this internal ice bank or ring, however, inherently reduces the overall available chilled water storage capacity of the reservoir. As a result, the residence time for a given water volume within the reservoir is reduced, whereby effective chilling of the water to a desired refreshing low temperature may be difficult or impossible particularly when relatively large volumes of water are dispensed within relatively short time intervals. This problem is compounded further by a tendency of refill water, upon entering the reservoir to replace a dispensed water increment, to flow relatively directly through a central region of the ice-reduced reservoir volume to a dispensing outlet, with minimal or limited thermal contact with or chilling by the ice block. In other words, especially when large volumes of water are dispensed at short time intervals, water flow through the reservoir can result in temperature stratification zones within the reservoir interior, with warmer temperature water tending to flow first to the dispensing outlet or outlets.

There exists, therefore, a need for further improvements in and to chiller reservoirs of the type used in a water cooler or water purification system or the like, for insuring relatively rapid and efficient cooling of each water volume increment circulated to and through the reservoir. The present invention fulfills these needs and provides further related advantages.

### SUMMARY OF THE INVENTION

In accordance with the invention, an improved chiller reservoir is provided for use in a water cooler or the like for chilling a supply of water circulated therethrough. The reservoir defines a substantially enclosed internal volume having a refrigerated outer wall carrying chiller means such as a chiller coil or the like for cooling water contained within the reservoir. At least one and preferably a plurality of apertured baffle plates are mounted within the reservoir at spaced-apart locations, and function to cause the water to flow along an ice bank formed thereon, for improved and relatively rapid chilling.

In the preferred form, the chiller reservoir defines first and second opposite ends, with the refrigerated outer wall and associated chiller means extending therebetween. A water inlet port is positioned at said reservoir first end, and admits water to a central inlet tube which extends through the reservoir interior and discharges the water inflow into the reservoir near said reservoir second end. A plurality of spaced-apart baffle plates are mounted within the reservoir, as by mounting on the central inlet tube. These baffle plates subdivide the reservoir interior into a succession of water flow chambers, with the apertures formed in the baffle plates arranged so that the water must flow through this succession of chambers in a sequence of direction-changing steps.

More particularly, in the preferred form, at least three baffle plates are provided in spaced-apart relation within the reservoir interior. A first baffle plate positioned in spaced relation with said reservoir second end includes flow apertures such as slots formed generally in the periphery thereof, whereby water discharged from the central inlet tube is required to flow generally radially outwardly toward the refrigerated outer wall in order to pass axially through the apertured first baffle plate in a direction back toward said reservoir first end. Such water flow is then required to flow generally radially inwardly toward the central inlet tube for further axial passage through flow ports formed near the center of a second or centrally positioned baffle plate, and then change direction to flow generally radially outwardly again for passage axially through peripheral flow apertures formed in a third baffle plate located near said reservoir first end. A water outlet port, coupled to a suitable dispensing faucet or like, is positioned at or adjacent said first reservoir end.

The baffle plates thus require the water supplied to the reservoir to circulate along a direction-changing flow path wherein the water is guided toward and against and/or along the refrigerated outer wall, or against an ice bank formed thereon, for improved and relatively rapid chilling, and for substantial intermixing of refill and residual water within the reservoir. In a preferred configuration, the chiller reservoir may have a generally cylindrical cross sectional shape extending generally horizontally between said first and second ends.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view, shown somewhat in schematic form, illustrating a chiller reservoir constructed in accordance with the present invention; and

FIG. 2 is a transverse vertical sectional view taken generally on the line 2-2 of FIG. 1.

### DETAILED DESCRIPTION OF THE PREFERRED EMBODIMENT

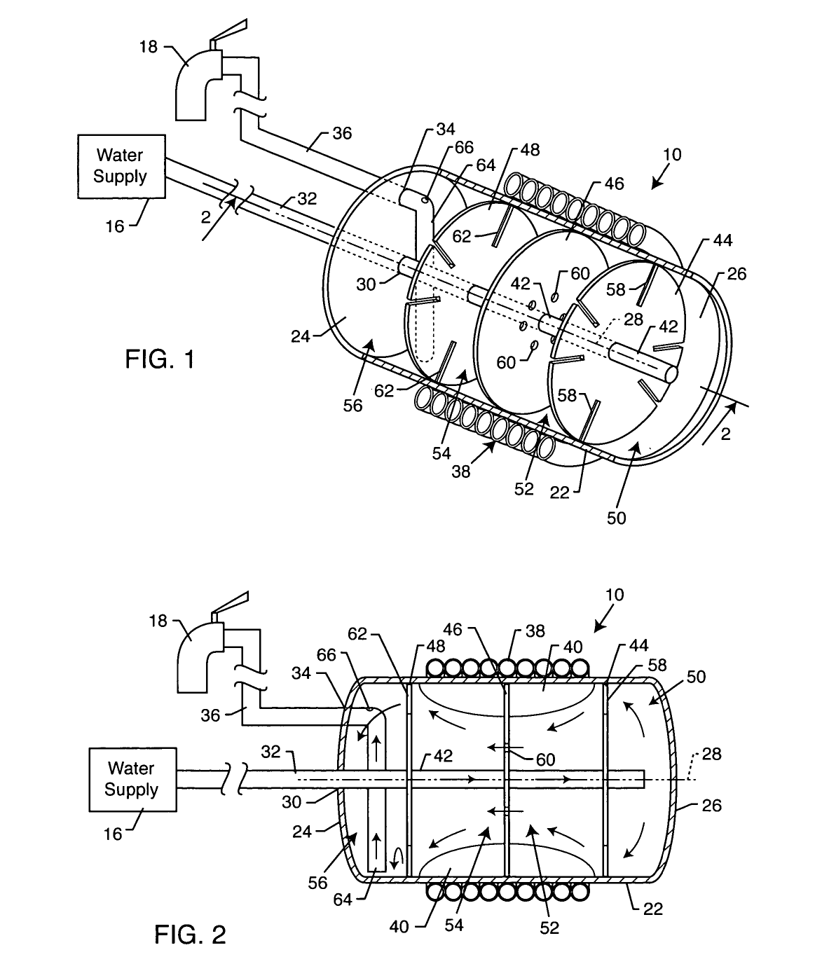

As shown in the exemplary drawings, an improved chiller reservoir referred to generally in FIGS. 1-2 by the reference numeral 10 is provided for chilling water. The chiller reservoir 10 normally comprises a portion of a water dispensing system, such as a water cooler or a water purification system or the like, wherein a water inflow to the reservoir 10 is provided from a suitable water supply or source 16, and further wherein a water outflow from the reservoir is typically adapted for dispensing as by means of one or more dispensing faucets 18. In accordance with the invention, the improved chiller reservoir 10 is designed for relatively rapid and efficient chilling of water or the like circulated therethrough.

FIGS. 1 and 2 depict the chiller reservoir 10 in one preferred form, wherein the reservoir has a generally cylindrical shape defining a substantially enclosed internal volume of selected size for receiving and storing a predetermined volume of water. In this regard, the illustrative cylindrical reservoir 10 includes a generally cylindrical outer wall 22 extending between an opposed pair of first and second end walls 24 and 26, respectively. As shown, the reservoir 10 may be oriented with a central axis 28 to extend generally horizontally, although persons skilled in the art will recognize and appreciate that alternative reservoir orientations may be used. An inlet port 30 is provided for water inflow into the reservoir interior as by means of a suitable inflow conduit 32 or the like coupled to the water source 16, such as an inverted water bottle of typically three to five gallon capacity, or a tap water supply or the like which may be filtered or otherwise treated (e.g., by means of a reverse osmosis purification system or the like) to remove undesired levels of contaminants. An outlet port 34 is provided for water outflow from the reservoir interior as by means of a suitable outflow conduit 36 or the like coupled to the at least one dispensing faucet 18.

Water within the reservoir 10 is chilled to a relatively low and refreshing temperature by chiller means 38, such as the illustrative chiller coil wrapped spirally about a central region of the cylindrical outer wall 22 of the reservoir. In this regard, this chiller coil 38 may comprise an evaporator cooling coil forming a portion of a conventional mechanical refrigeration system of the type including a compressor, heat exchanger, and expansion valve (not shown) for circulating a refrigerant at relatively low temperature through the chiller coil. Mounting of the chiller coil 38 about the outer wall 22, or otherwise suitably integrating the chiller coil 38 into the said outer wall 22, provides the reservoir 10 with a refrigerated outer wall for reducing the temperature of water therein. Thermostatic controls (also not shown) are normally incorporated into the refrigeration system for cycling the refrigeration system on and off, in a manner designed to maintain the reservoir water temperature at a predetermined target temperature. As is known in the art, the refrigeration system is commonly cycled on and off to produce and maintain an annular ice bank or ice block 40 (FIG. 2) of generally predetermined size lining the interior surface of the refrigerated outer wall 22.

The inlet port 30 is formed in the first end wall 24 of the reservoir 10, at a location generally corresponding with the central axis 28. Water inflow through this inlet port 30 is coupled a central inlet tube 42 which extends into the reservoir interior, preferably along a line that is generally coincident with the central axis 28. This central inlet tube 42 guides the water inflow to a distal or downstream end thereof which is spaced a short distance from the opposite or second end wall 26 of the reservoir 10. Water inflow to the reservoir interior is thus discharged by the central inlet tube 42 at a location near the second end wall 26. From this point, as will be described herein in more detail, the water is circulated back toward the first end wall 24 which also has the outlet port 34 formed therein, for further on-demand flow and dispensing via the faucet 18. Importantly, as the water is circulated back toward the first end wall 24, the water undergoes a plurality of directional flow changes to achieve improved chilling thereof.

More particularly, at least one and preferably a plurality of baffle plates are mounted in spaced-apart relation within the reservoir interior to subdivide the reservoir interior into multiple axially separated chambers. The illustrative drawings show three such baffle plates 44, 46 and 48 each having a generally circular or disk-like shape adapted for mounting onto the central inlet tube 42 and defining an outer periphery disposed in contact or close-contact relation with the refrigerated outer wall 22. These three baffle plates 44, 46 and 48 subdivide the reservoir interior 20 into a spaced-apart succession of four water flow chambers 50, 52, 54 and 56. Persons skilled in the art will recognize that different numbers of baffle plates, defining a different number of water flow chambers, may be used.

The baffle plates 44, 46 and 48 are apertured to permit axial water flow therethrough, thereby accommodating water circulation from the distal end of the central inlet tube 42 disposed within the first chamber 50 in series-flow relation back through the second, third and fourth chambers 52, 54 and 56, respectively, in a direction toward the outlet port 34. However, the positions of the apertures formed in this succession of baffle plates changes from one baffle plate to the next. That is, as shown in the exemplary drawings, the first baffle plate 44 has a plurality of apertures 58 such as radially elongated slots formed near the outer periphery thereof. Thus, water inflow from the central inlet tube 42 flows radially outwardly within the first flow chamber 50 and passes axially through the apertures 58 in a direction back toward the outlet port 34 and into the second chamber 52. As the water travels axially through these apertures, the water is forced to flow near or along the inboard surface of the refrigerated outer wall 22, and/or along the internal surface of any ice bank 40 formed thereon, for substantially optimized temperature reduction of the water flow.

The second baffle plate 46 also includes a plurality of apertures 60 formed therein, but these apertures comprise an array of small flow ports formed near the central inlet tube 42. Thus, as the water flow exits the second flow chamber 52, the water must travel radially inwardly to the apertures 60, and then pass therethrough into the third flow chamber 54.

Within the third flow chamber 54, the water must change direction again and travel generally in a radially outward direction for passage to apertures 62 such as radial slots formed at or near the periphery of the third baffle plate 48. As the water travels in this radially outward direction, the water is again directed toward and along the refrigerated outer wall 22, and/or along the ice bank 40, for substantially optimized temperature reduction. The water flows through the peripheral apertures 62 into the fourth flow chamber 56 adjacent the first end wall 24. A downwardly open exit tube 64 within this chamber 56 provides a flow path for water flow to the outlet port 34, and passage further through the dispense conduit 36 to the faucet 18 or the like. FIGS. 1-2 show the outlet port 34 formed in the first end wall 24 at a position near an upper margin thereof, and with the exit tube 64 having an open lower end positioned within a lower region of the reservoir, and further defining a vented tube segment having a small vent 66 formed therein within an upper region of the reservoir, such as at the inboard side of the outlet port 34. With this arrangement, air within the reservoir 10, prior to initial filling of the reservoir with water, is exhausted through the outlet port 34.

The direction-changing circulation of water through the succession of reservoir flow chambers 50, 52, 54 and 56 thus repeatedly causes the water to flow against the refrigerated outer wall 22 of the reservoir 10, or toward and against and along the ice bank 40 formed within said outer wall, for rapid and efficient chilling of the water. In addition, this direction-changing circulation beneficially mixes a refill water inflow increment with the remaining residual water within the reservoir, for further achieving rapid and efficient chilling of water.

A variety of further modifications and improvements in and to the improved chiller reservoir 10 of the present invention will be apparent to those persons skilled in the art.

1. A chiller reservoir, comprising:
a reservoir defining a substantially enclosed internal volume for receiving and storing a volume of water, said reservoir having first and second opposite ends;
water inflow means for discharging water into said reservoir generally adjacent said second end thereof, and water outflow means for water outflow from said reservoir generally at said first end thereof;
chiller means carried by said reservoir for chilling water within said reservoir, said chiller means being positioned generally between said first and second opposite ends of said reservoir; and
a plurality of baffles subdividing said reservoir internal volume into a succession of chambers between said first and second opposite ends, said baffles being configured to cause direction-changing flow of water through said chambers from said second end to said first end for improved chilling.

2. The chiller reservoir of claim 1 wherein said reservoir has a generally cylindrical shape defining a cylindrical outer wall extending between said first and second opposite ends, said chiller means comprising a chiller coil carried by said outer wall.

3. The chiller reservoir of claim 1 wherein said plurality of baffles comprises a spaced-apart array of baffle plates mounted within said reservoir, each of said baffle plates having a periphery disposed generally in close proximity to said chiller means, each of said baffle plates having at least one flow aperture formed therein for direction-changing flow of water generally toward and away from said chiller means upon travel from said second end to said first end.

4. The chiller reservoir of claim 3 wherein said plurality of baffle plates comprise a first and second baffle plates respectively positioned in generally adjacent spaced relation to said first and second ends of said reservoir, and a third baffle plate positioned in spaced relation between said first and second baffle plates, said first and second baffle plates each having flow apertures formed generally at the peripheries thereof, and said third baffle plate having at least one flow aperture formed generally at a central location therein.

5. The chiller reservoir of claim 4 wherein said water outflow means comprises an exit tube having an open end disposed generally within a lower region of said reservoir internal volume, and including a vented segment disposed within an upper region of said reservoir internal volume.

6. The chiller reservoir of claim 4 wherein said water inflow means comprises an inlet tube extending from said first end of said reservoir through said internal volume for discharging water inflow into said reservoir at a position generally adjacent said reservoir second end, said baffle plates being carried by said inlet tube.

7. A chiller reservoir, comprising:
a reservoir having a generally cylindrical shape including a generally cylindrical outer wall extending between first and second opposite end walls, said reservoir defining a substantially enclosed internal volume for receiving and storing a volume of water;
chiller means carried by said reservoir outer wall for chilling water within said reservoir;
water inflow means for discharging water into said reservoir generally adjacent said second end wall, and water outflow means for outflow of water generally adjacent said first end wall; and
a plurality of at least three baffle plates mounted within said reservoir in spaced-apart relation and subdividing said reservoir internal volume into a succession of chambers between said first and second end walls, said baffle plates defining flow apertures for causing direction-changing flow of water generally toward and away from said outer wall upon water from through said chambers from adjacent said second end wall to adjacent said first end wall.

8. The chiller reservoir of claim 7 wherein said water outflow means comprises an exit tube having an open end disposed generally within a lower region of said reservoir internal volume, and including a vented segment disposed within an upper region of said reservoir internal volume.

9. The chiller reservoir of claim 7 wherein said water inflow means comprises an inlet tube extending from said first end of said reservoir through said internal volume for discharging water inflow into said reservoir at a position generally adjacent said reservoir second end, said baffle plates being carried by said inlet tube.

10. A chiller reservoir, comprising:
a reservoir having a generally cylindrical shape including a generally cylindrical outer wall extending between first and second opposite end walls, said reservoir defining a substantially enclosed internal volume for receiving and storing a volume of water;
a water inlet port and a water outlet port positioned generally at said first end wall for respect introduction of water into and withdrawal of water from said reservoir;
an inlet tube mounted within said reservoir and extending from said inlet port to a position generally adjacent said second wall, said inlet tube discharging water inflow into said reservoir at a position generally adjacent said second wall;
chiller means carried by said reservoir outer wall for chilling water within said reservoir; and
a plurality of at least three baffle plates carried on said inlet tube within said reservoir in spaced-apart relation and subdividing said reservoir internal volume into a succession of chambers between said first and second end walls, said baffle plates each having a periphery in close proximity to said chiller means, said baffle plates further defining flow apertures for causing direction-changing flow of water generally toward and away from said outer wall upon water flow within said reservoir from through said chambers from adjacent said second wall to adjacent said first wall.

11. The chiller reservoir of claim 10 further including an exit tube within said reservoir and extending between said outlet port and an open end disposed generally within a lower region of said reservoir internal volume, said exit tube further including a vented segment between said outlet port and said open end and disposed generally within an upper region of said reservoir internal volume.

12. A chiller reservoir, comprising:
a reservoir defining a substantially enclosed internal volume for receiving and storing a volume of water, said reservoir having first and second opposite ends;
water inflow means for discharging water into said reservoir generally adjacent said second end thereof, and water outflow means for water outflow from said reservoir generally at said first end thereof;
chiller means carried by said reservoir for chilling water within said reservoir, said chiller means being positioned generally between said first and second opposite ends of said reservoir; and
at least one baffle subdividing said reservoir internal volume into a succession of chambers between said first and second opposite ends, said at least one baffle being configured to cause flow of water into close proximity with said chiller means upon water from through said chambers from said second end to said first end.
